(19) United States
(12) Patent Application Publication
(10) Pub. No.: US 2004/0245156 A1
(43) Pub. Date: Dec. 9, 2004

(54) Sorting system for sheeted material

(76) Inventors: Paul G. Gaddis, Seattle, WA (US); Scott Anderson, Smyrna, TN (US); Arthur Doak, Nashville, TN (US); Michael R. Grubbs, Nashville, TN (US)

Correspondence Address: WADDEY & PATTERSON, 414 UNION STREET, SUITE 2020, BANK OF AMERICA PLAZA, NASHVILLE, TN, 37219

(21) Appl. No.: 10/457,077

(22) Filed: Jun. 6, 2003

(51) Int. Cl. B03B 5/54; B03B 5/52; B03B 5/68; B03B 5/58; B03B 5/56; B03B 5/70

(52) U.S. Cl. 209/446

(57) ABSTRACT

A sorting system for sheeted material is presented, the sorting system including a path for travel of the sheeted material; an entrainment gas source for providing a first flow of gas in a direction substantially the same as the path for travel of the sheeted material; a plurality of receiving bins for receiving the sheeted material; a directional gas source associated with at least one of the plurality of receiving bins for providing a flow of gas directed to maintain the sheeted material entrained in the first flow of gas; a sorter associated with at least one of the plurality of receiving bins for directing selected ones of the sheeted material into such receiving bin.

### TECHNICAL FIELD

The present invention relates to a sorting system for sheeted material, such as paper and paperboard. Indeed, the inventive system is particularly applicable for use in the waste paper recycling industry, and can be used for efficiently sorting paper and other sheeted material by certain predetermined characteristics.

### BACKGROUND OF THE INVENTION

Environmental campaigns and recycling efforts in many areas have generated a substantial supply of recyclable waste paper and like materials. These materials need to be sorted before they can be recycled. For instance, colored stock often needs to be separated from white stock, and glossy stock from flat stock. In addition, it is sometimes necessary or desirable to separate printed materials from blank materials. Unfortunately, sorting of waste paper and paperboard, etc. is still currently performed almost entirely by manual sorting. Manual sorting of such materials can be time consuming and expensive, which can render the use of recycled paper less economical than virgin paper material.

Numerous automated waste separation techniques are known. However, these techniques are generally designed for the recovery of metals, alloys, municipal waste, mixed recyclables and plastics. Paper (or, more generally, sheeted material) sorting presents unique problems that cannot be overcome by most prior art separation techniques. For instance, the relatively light weight and flexible nature of paper presents unique problems when sorting is attempted. Indeed, these problems make it difficult to supply paper to a sorting sensor, especially not at a desirable feed rate (usually defined in terms of feet per minute (fpm), but sometimes also in pterms of pieces or objects per minute (ppm) or tons per hour (tph)). Without higher speeds, automated sorting systems do not achieve an efficiency substantially greater than manual sorting.

Moreover, most prior art paper sorting systems are only capable of limited sorting flexibility. More specifically, prior art systems are generally only capable of sorting paper or other sheeted material into two bins, a “default” bin at the terminus of a conveyor and one “selection” bin into which specifically selected individual ones of the sheeted material are ejected.

What is desirable, therefore, is a sorting system for sheeted material such as waste paper, which permits sufficient feed rates to be more economical and which is capable of permitting the sorting of paper by more than one characteristic (i.e., into more than simply a default bin and one selection bin).

### SUMMARY OF THE INVENTION

The present invention relates to handling and sorting systems and methods for paper and other sheeted material. By sheeted material is generally meant a collection of material made up of individual ones, each having a thickness no greater than about 5% of the circumference of the material, such as the sum of the length and width in the case of rectangular material like paper.

In one embodiment, the inventive sorting system includes a path along which the sheeted material travels, such as a conveyor, and a source of an entrainment gas providing a flow of gas in the same direction of the path of travel of the sheeted material. In order to optimize the travel of the sheeted material in the path of travel, the path of travel preferably assumes a downward trajectory. A plurality of receiving bins are disposed along the path of travel of the sheeted material, one of the receiving bins being a default bin, into which sheeted material not otherwise selected is directed and one (and more preferably two) of the receiving bins being a selection bin into which selected individual ones of the sheeted material can be directed.

A directional gas source is associated with at least one of the selection bins, the directional gas source providing a flow of gas which maintains the sheeted material entrained in the entrainment gas flow. More specifically, the directional gas source provides a flow of gas across the opening of the selection bin with which it is associated, to prevent sheeted material from inadvertently entering the bin. A sorter such as an injector is also associated with at least one of the selection bins for directing selected ones of the sheeted material into the selection bin with which it is associated.

As noted, in a preferred embodiment, there are at least two selection bins along the path of travel of the sheeted material, along with a default bin at its terminus. Most advantageously, the selection bins for the sheeted material are each arrayed below the path of travel to most efficiently sort the material as it travels along the path of travel. Generally, both the entrainment gas and the directional gas comprise air and each of the selection bins has both a directional gas source and a sorter associated with it. The sorters preferably comprise gas jets, but can also be a mechanical arm or other like sorting apparatus.

Upstream from the receiving bins, along the path of travel of the sheeted material, there is a sensor for determining one or more characteristics of individual ones of the sheeted material as the sheeted material is traveling along the path of travel. For instance, the sensor can determine color, reflectivity (indicative of whiteness), presence of printing, etc. The sensor then provides a signal which actuates one or more of the sorters in response to the determination. For instance, when the sorter detects paper having a certain reflectivity, it can actuate the sorter associated with a first selection bin which thus directs the detected high reflectivity (or whiteness) into such first selection bin. Likewise, when the sensor detects the presence of printing on a low reflectivity (or less white) individual one of the sheeted material, it can actuate the sorter associated with the second selection bin and thus direct the printed, low reflectivity sheet into the second selection bin. When neither of these characteristics is detected by the sensor, the sensor does not actuate either sorter and thus allows the sheets, which are low reflectivity and have no printing, to flow into the default bin. In this way, the sheeted material is separated into high reflectivity sheets, low reflectivity sheets with printing, and sheets that are low reflectivity and have no printing.

Accordingly, it is an object of the present invention to provide a sorting system for sheeted material.

Another object of the present invention is to provide a sorting system for sheeted material which permits sorting by two or more characteristics.

A further object of the present invention is to provide a sorting system for sheeted material, such as paper, paperboard, cardboard, plastic or combinations thereof, and which permits sorting at a feed rate so as to be economical as compared to prior art paper sorting systems.

Yet another object of the present invention is to reduce the need for manual sorting of waste paper streams.

Still another object of the present invention is to provide a system and method for achieving automated sorting of sheeted material on a cost effective basis.

Yet another object of the present invention is to provide a system and method for achieving improved consistency and repeatability in the sorting of recyclable sheeted material.

These objects and others which will be apparent to the skilled artisan upon reading the following description, can be achieved by providing a sorting system for sheeted material (which can include paper, paperboard, cardboard, plastics and the like which has a thickness no greater than about 5% of its circumference) which includes a path for travel of the sheeted material, such as a conveyor belt; an entrainment gas source for providing a first flow of gas in a direction substantially the same as the path for travel of the sheeted material; a plurality of receiving bins for receiving the sheeted material; a directional gas source associated with at least one of the plurality of receiving bins for providing a flow of gas directed to maintain the sheeted material entrained in the first flow of gas; a sorter associated with at least one of the plurality of receiving bins for directing selected ones of the sheeted material into such receiving bin.

Preferably, both the entrainment gas and the directional gases are air, and at least two of the receiving bins each have a directional gas source and a sorter associated therewith. The sorters advantageously each comprise a gas jet. The inventive system also preferably includes a sensor for determining one or more selected characteristics of ones of the sheeted material, the sensor providing a signal actuating one or more of the sorters in response to such determination.

The present invention also includes a method for sorting sheeted material, the method including providing an entraining flow of gas (i.e., air) to assist travel of the sheeted material along a specified path; providing a plurality of receiving bins for receiving the sheeted material; providing a directional flow of gas associated with at least one of the plurality of receiving bins, the directional flow of gas (i.e., air) directed to maintain the sheeted material entrained in the entraining flow of gas; directing selected ones of the sheeted material into at least one of the plurality of receiving bins.

It is to be understood that both the foregoing general description and the following detailed description present embodiments of the invention, now intended to provide an overview or framework of understanding the nature and character of the invention as it is claimed. The accompanying drawings are included to provide a further understanding of the invention and are incorporated in and constitute a part of this specification. The drawings illustrate various embodiments of the invention, and together with the description serve to explain the principles and operations of the invention.

### BRIEF DESCRIPTION OF THE DRAWINGS

FIG. 1 is a side cross-sectional view of one embodiment of the sorting system of the present invention.

FIG. 2 is a transverse cross-sectional view of the sorting system of FIG. 1, facing against the direction of travel of sheeted material, and taken along lines 2-2.

FIG. 3 is a transverse cross-sectional view of the sorting system of FIG. 1, facing against the direction of travel of sheeted material, and taken along lines 3-3.

### DETAILED DESCRIPTION OF THE PREFERRED EMBODIMENTS

Embodiments of the present invention will now be described in greater detail with respect to the aforementioned drawings. Like or similar reference numerals will be used whenever possible, although not every reference numeral will necessarily be used in each drawing, for the sake of ease of understanding. The sorting system of the present invention will be described in terms of use for sorting recyclable waste paper; such is for convenience only. It will be understood that the inventive sorting system can be applied to the sorting of any sheeted material in a variety of environments. Likewise, the invention will be described with respect to a specific orientation and relationship of elements with respect to each other, but it will be recognized by the skilled artisan that other orientations and relationships will be equally applicable unless otherwise stated.

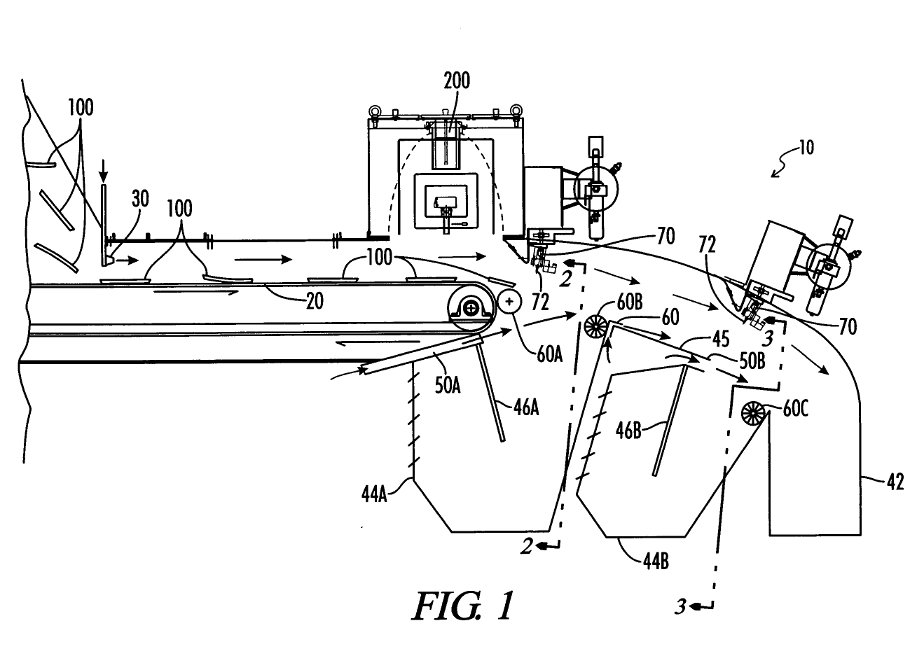

In a preferred embodiment, illustrated in FIG. 1, the present invention relates to a sorting system 10 for sorting sheeted material 100, such as waste paper. Sorting system 10 comprises a path of travel of sheeted material 100, defined by the travel of a conveyor 20. Conveyor 20 can comprise any conveyor used for moving sheeted material 100 or the like, such as a roller or conveyor belt and be formed of fabric, mesh, rubber, etc. as would be familiar to the artisan. Advantageously, conveyor 20 is made of a material which provides sufficient friction to maintain sheeted material 100 traveling the path of travel, to the extent possible. Conveyor 20 is typically driven at the desired rate of travel of sheeted material 100 along the path of travel, as discussed in more detail hereinbelow.

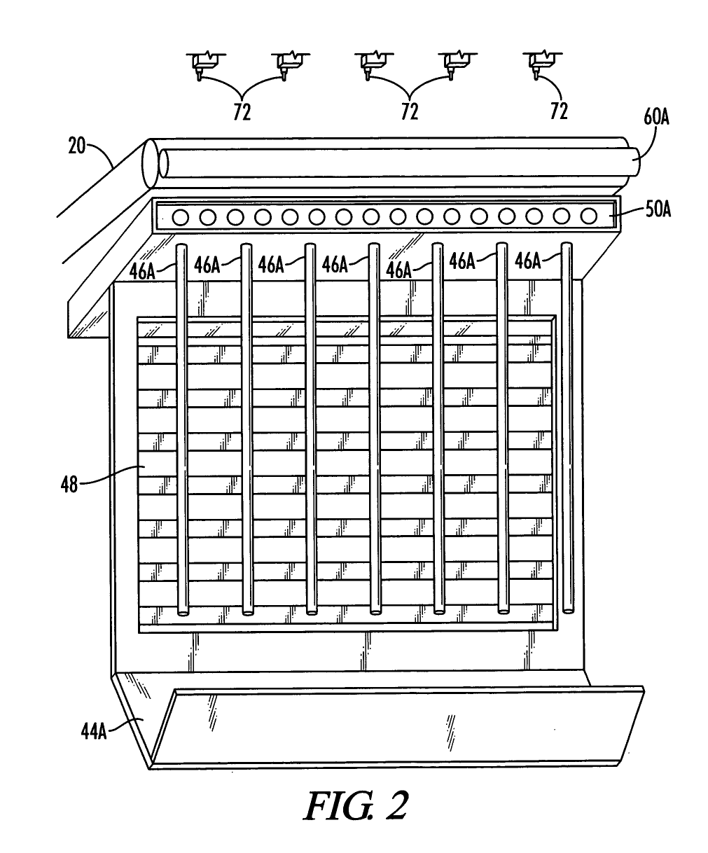

Still referring to FIG. 2, sorting system 10 also comprises a source of entrainment gas 30 which produces a flow of gas, especially air, used to entrain sheeted material 100 traveling along conveyor 20, and indicated by arrows. The use of entrainment gas is important because, at the feed rates which make an automated sorting system economical, sheeted material 100 would normally not be able to be consistently transported along conveyor 20 without floating and moving in various directions other than directly within the path of travel, even when conveyor 20 is a belt with a high degree of friction. Put simply, at the desired feed rates, the relative low thickness to surface area ratio of sheeted material 100 would cause air to flow between a leading edge of sheeted material 100 and conveyor 20 as sheeted material 100 travels along its path of travel, causing sheeted material 100 to lift off conveyor 100. Entrainment air provided by source 30 can maintain sheeted material 100 flowing in the proper path along conveyor 20, even at feed rates as high as 800 fpm, or higher. Indeed, feed rates as high as 1000 fpm and higher can be utilized in sorting system 10 of the present invention.

In addition to the use of entrainment air, it is also contemplated that other systems can be employed to maintain the sheeted material spread consistently on conveyor 20 and flowing in the proper direction. Exemplary of such a system is that disclosed, for instance by, Grubbs, Kenny and Gaddis in U.S. Pat. No. 6,250,472, the disclosure of which is incorporated herein by reference.

Inventive sorting system 10 further comprises a plurality of receiving bins 40 into which sheeted material 100 traveling along conveyor 20 can be directed. Receiving bins 40 comprise a “default” receiving bin 42 into which sheeted material 100 will flow if not directed into any of the preceding receiving bins, as well as at least one “selection” bin 44, and in the embodiment shown in FIG. 1, two selection bins 44A and 44B, into which selected individual ones of sheeted material 100 can be directed, depending on particular characteristics of the selected sheeted material 100.

Any or all of receiving bins 40 can comprise a structure, such as “lobster trap” rods 46 (illustrated in FIGS. 1-3) which will keep the sheeted material within the specific receiving bin, even in the event of eddying or roiling gas currents. For instance, and as illustrated in FIGS. 1 and 2, selection bin 44A comprises lobster trap rods 46A, which permit sheeted material 100 to enter selection bin 44A below rods 46A, but prevent the sheeted material 100 which has entered selection bin 44A to from being forced out past rods 46A likewise, selection bin 44B has lobster trap rods 46B). It will be recognized, however, that other structures such as mesh screens or solid walls (not shown) can also function to keep sheeted material 100 within the respective bins once it has entered.

In addition, vents 48 can be provided in each of selection bins 44A and 44B to vent off excess gas flow in selection bins 44A and 44B. Vents 48 can comprise louvers, especially mesh-covered louvers (not shown), in order to effectively vent off excess gas in the bins.

Moreover, receiving bins 40 can also comprise doors (not shown) to allow for the emptying out of sheeted material 100. In the alternative, sheeted material 100 can be emptied from receiving bins 40 during times when sorting system 10 is not operating.

Selection bins 44A and 44B can also have associated therewith a source of directional gas 50A and 50B. Directional gals sources 50A and 50B comprise conduits for gas (e.g. air) flow in a direction across the top opening of each of selection bins 44A and 44B (and indicated by arrows) to ensure that sheeted material 100 flowing along with the entrainment gas does not inadvertently enter receiving bins 44A and 44B. In other words, because the openings of receiving bins 40 would ordinarily cause eddying and other current variations of entrainment gas, it is possible that, without the use of directional gas flow, individual ones of sheeted material 100 may enter one of selection bins 44A and 44B when not intended. Directional gas sources 50A and 50B provide a directional gas flow to maintain the flow of sheeted material 100 along the flow of entrainment gas. Typically, directional gas sources 50A and 50B are powered by fans or blowers (not shown).

As illustrated in FIG. 1, directional gas sources 50A and 50B can be arrayed so as to make use of the structures defining the walls of selection bins 44A and 44B. For instance, directional gas source 50A, used for selection bin 44A, can comprise a conduit running between selection bin 44A and conveyor 20. Likewise, directional gas source 50B, used for selection bin 44B, can comprise a conduit extending through the structure forming the wall separating selection bin 44A and selection bin 44B.

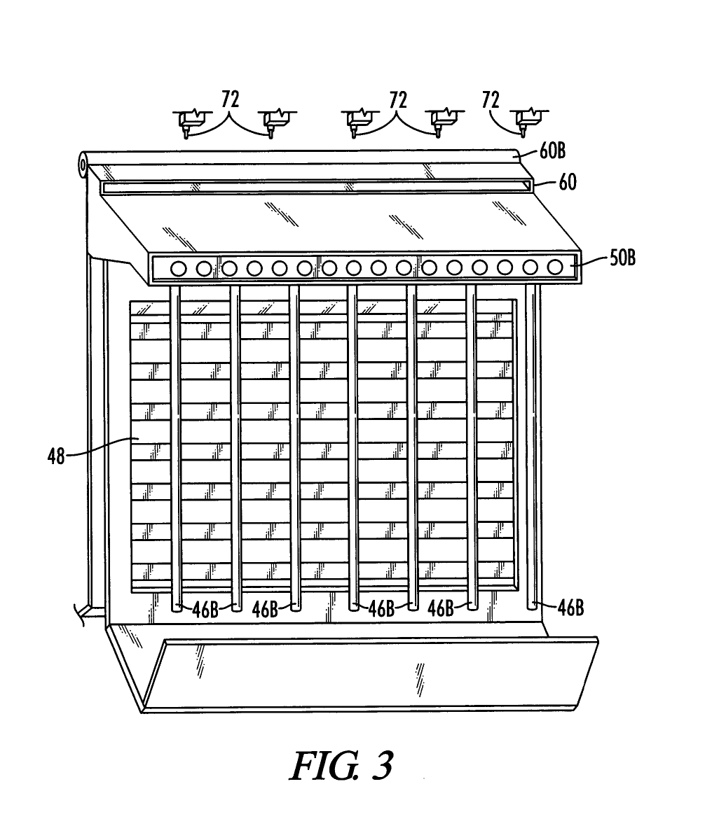

In addition, the possibility exists on any surface after the termination of conveyor 20 that the flow of sheeted material 100 may be interrupted due to friction. In order to reduce this possibility, in another preferred embodiment, a fluidizing flow of gas can also be created along such surface such as by providing a source of fluidizing gas 60 which creates a fluidizing flow of gas along the surface (indicated by arrows) to keep sheeted material 100 from being hung up. For instance, the gas flow from directional gas source 50B can be partially diverted to be outletted at a proximate end of the surface 45 between the openings of selection bin 44A and 44B, as illustrated in FIGS. 1 and 3. This diverted gas flow forms a fluidizing layer of gas along the surface, thus helping to prevent sheeted material 100 from being caught on surface 45. Moreover, rollers, such as 60A, 60B, and 60C can be positioned to facilitate the flow of sheeted material 100 along the flow path of the entrainment gas, and otherwise to help prevent sheeted material 100 from being caught on corners or other elements of sorting system 10. Rollers 60A, 60B, and 60C can be driven or passive, but are preferably passive rollers.

Each of selection bins 44A and 44B also has a sorter 70 associated therewith to direct selected individual ones of sheeted material 100 into the respective selection bin 44A or 44B. Sorter 70 preferably comprises an air jet or other like device which, when actuated, will cause the selected sheeted material 100 to pass through any directional gas flow across the opening of the specific selection bin 44A or 44B and thereinto.

More preferably, sorter 70 can comprise a plurality of air jets 72 extending generally across the width of sorting system 10. In this manner, when individual ones of the sheeted material 100 is arrayed cross the width of conveyor 20 and the path of travel of sheeted material 100, individual ones across the width of the path of travel of sheeted material 100 can be selected to be directed into one of the selection bins 44A or 44B by actuating only those air jets 72 as would direct the selected sheeted material 100 into the respective receiving bin 40.

Upstream from the first selection bin 44A, sorting system 10 comprises a sensor 80 capable of detecting one or more characteristics of sheeted material 100 flowing along conveyor 20. Characteristics detected by sensor 80 can comprise reflectance (indicative of whiteness), color, presence of printing, or other characteristics of sheeted material 100. Exemplary of sensor systems which can be used in conjunction with sorting system 10 are those disclosed by Bruner, Morgan, Kenny, Gaddis, Lee and Roggow in U.S. Pat. No. 6,369,882, the disclosure of which is incorporated herein by reference. In this system, ultraviolet light is used to detect presence of paper having a certain reflectivity, indicative of whiteness. Signals from sensor 80 are provided to a microprocessor 200 which then can provide a control system to sorters 70 to direct sorters 70 to direct individual ones of sheeted material 100 into selection bins 44A or 44B provided certain measured criteria are met, or, microprocessor 200 can permit sheeted material 100 to flow past selection bins 44A and 44B, by not actuating any of sorters 70, and thus be directed into default bin 42 if selection criteria are not met, or vice versa.

In operation, sheeted material 100 is fed onto conveyor 20 using, e.g., the system disclosed by Grubbs, Kenny and Gaddis in U.S. Pat. No. 6,250,472. Entrainment airflow is also directed in the direction of the flow of travel of sheeted material 100 defined by conveyor 20, along the direction indicated by the arrows in FIG. 1. As sheeted material 100 continues along conveyor 20 as directed by the entrainment gas, sheeted material 100 passes by sensor 80 which detects and/or measures the presence or absence of certain criteria, such as whiteness, color, printed matter, etc. Sheeted material 100 then flows across the openings of selection bins 44A and 44B as facilitated by the directional gas provided by directional gas sources 50A and 50B as well as fluidizing gas provided by source 60 and into default bin 42. However, when sheeted material 100 meeting certain criteria, such as reflectivity, etc., passes by sensor 80, a signal is sent from sensor 80 to microprocessor 200 which then actuates one or more sorters 72 to direct individual one of sheeted material 100 into one of the respective selection bins 44A and 44B. In this manner, sorting of sheeted material 100 such as paper can be accomplished at sufficiently high speeds and with sufficient accuracy and flexibility to be economical.

All cited patents and publication referred in this application are incorporated by reference.

The invention thus being described, it will be apparent that it may be varied in many ways. Such variations are not to be regarded as a departure from the spirit and scope of the present invention and all such modifications as would be apparent to one skilled in the art are intended to be included within the scope of the following claims.

What is claimed is:

1. A sorting system for recyclable waste paper, comprising:
a. a conveyor belt for transporting the waste paper;
b. a source of air flow for providing a flow of entrainment air in a direction substantially the same as that of the conveyor;
c. at least three receiving bins for receiving the paper, wherein the at least three receiving bins comprise at least two selection bins into which individual pieces of the paper can be sorted and disposed below the flow of entrainment air and a default bin into which paper not sorted into the at least two selection bins flows;
d. a directional air source associated with each of the selection bins for providing a flow of air directed to maintain the paper entrained in the flow of entrainment air;
e. a sorter associated with each of the selection bins for directing selected pieces of the paper material into such selection bin.

2. The system of claim 1 which comprises two selection bins.

3. The system of claim 2 wherein the sorters each comprise a gas jet.

4. The system of claim 1 which further comprises a sensor for a plurality of selected characteristics of the paper, the sensor providing a signal actuating one or more of the sorters in response to such determination.

5. The system of claim 4 wherein the flow of entrainment air continues beyond the end of the conveyor belt in a downward trajectory.

6. A sorting system for sheeted material, comprising:
a. a path for travel of the sheeted material;
b. an entrainment gas source for providing a first flow of gas in a direction substantially the same as the path for travel of the sheeted material;
c. at least three receiving bins for receiving the sheeted material, wherein the at least three receiving bins comprise at least two selection bins into which individual ones of the sheeted material can be sorted and a default bin into which sheeted material not sorted into the at least two selection bins flows;
d. a directional gas source associated with at least one of the selection bins for providing a flow of gas directed to maintain the sheeted material entrained in the first flow of gas;
e. a sorter associated with at least one of the selection bins for directing selected ones of the sheeted material into such selection bin.

7. The system of claim 6 wherein the sheeted material comprises material having a thickness no greater than about 5% of the circumference.

8. The system of claim 7 wherein the sheeted material comprises paper, paperboard, cardboard, plastic or combinations thereof.

9. The system of claim 6 wherein the entrainment gas source comprises a source of air.

10. The system of claim 6 wherein each of the directional gas sources comprise a source of air.

11. The system of claim 6 which comprises two selection bins.

12. The system of claim 11 wherein each of the selection bins have a directional gas source and a sorter associated therewith.

13. The system of claim 12 wherein the sorters each comprise a gas jet.

14. The system of claim 6 which further comprises a sensor for determining a plurality of selected characteristics of ones of the sheeted material, the sensor providing a signal actuating one or more of the sorters in response to such determination.

15. The system of claim 6 wherein the path for travel of the sheeted material comprises a conveyor belt.

16. The system of claim 15 wherein the first flow of gas continues beyond the end of the conveyor belt in a downward trajectory.

17. The system of claim 16 wherein the selection bins are disposed below the first flow of gas.

18. A method for sorting sheeted material, comprising:
a. providing an entraining flow of gas to assist travel of the sheeted material along a specified path;
b. providing at least three receiving bins for receiving the sheeted material, wherein the at least three receiving bins comprise at least two selection bins into which individual pieces of the paper can be sorted and a default bin into which paper not sorted into the at least two selection bins flows;
c. providing a directional flow of gas associated with at least one of the selection bins, the directional flow of gas directed to maintain the sheeted material entrained in the entraining flow of gas;
d. directing selected ones of the sheeted material into at least one of the plurality of receiving bins.

19. The method of claim 18 wherein the sheeted material comprises material having a thickness no greater than about 5% of the sum of the length and width.

20. The method of claim 19 wherein the sheeted material comprises paper, paperboard, cardboard, plastic or combinations thereof.

21. The method of claim 18 wherein the entraining flow of gas comprises air.

22. The method of claim 18 wherein the directional flow of gas comprises air.

23. The method of claim 18 which comprises two selection bins.

24. The method of claim 23 wherein the selection bins are disposed below the entraining flow of gas.

25. The method of claim 23 wherein each of the selection bins have a directional flow of gas associated therewith.

26. The method of claim 18 wherein selected ones of the sheeted material are directed into at least one of the selection bins by sorters comprising gas jets.

27. The method of claim 26 which further comprises determining one or more selected characteristics of ones of the sheeted material and providing a signal actuating one or more of the sorters in response to such determination.

28. The method of claim 18 wherein the path for travel of the sheeted material comprises a conveyor belt.

29. The method of claim 28 wherein the entraining flow of gas continues beyond the conveyor belt in a downward trajectory.
